(19) United States
(12) Patent Application Publication
(10) Pub. No.: US 2007/0054550 A1
(43) Pub. Date: Mar. 8, 2007

(54) MULTI-DEVICE POWER CHARGER AND DATA COMMUNICATION DEVICE

(76) Inventors: David Cuthbert, Newton, MA (US); Larry Rogel, Brookline, MA (US); Matthew Page, Florence, MA (US); James Page, Florence, MA (US)

Correspondence Address: David Cuthbert, 20 St. James St., Newton, MA, 02458, US

(21) Appl. No.: 11/278,541

(22) Filed: Apr. 3, 2006

Related U.S. Application Data
(60) Provisional application No. 60/667,254, filed on Apr. 4, 2005.

(51) Int. Cl. H01R 13/648

(52) U.S. Cl. 439/607

(57) ABSTRACT

An apparatus which provides the ability to charge or power multiple devices from multiple different power sources, and to communicate electronic data to and from one of the devices. The apparatus utilizes simple construction, requiring no active electronics, thereby reducing the cost of production and the reliability of the device. The apparatus employs a single USB connection cable with connectors on both ends and a second power-only cable and connector which is connected to the power wires of the USB cable and thereby is able to power a second portable device from a single USB port. USB master provide sufficient power for two average portable devices without additional circuitry. Moreover, restricting the data path to only one device also eliminates the need for USB hub circuitry. Finally, greater end user flexibility is provided by using a USB male connector as the source of the data and power connection, a USB female connector for the output of the data and power connection, and a standard barrel-type power connector for the power-only output connection. Having two different output connectors ensures that the user will not confuse the two connectors.

### FIELD OF INVENTION

The Present invention relates to the field of recharging and data transfer of battery-powered electronic devices.

### BACKGROUND OF THE INVENTION

A common problem today is that people frequently have many low-power electronic devices that need power, need to have their batteries charged, or need a connection to a computer. Devices that an individual may need to power and/or charge typically include cell phones, Personal Digital Assistants (PDAs), portable/pocket computers, cameras, digital music players, video games, and other devices. This situation presents difficulty because each device typically comes with its own unique charger and each one takes up limited outlet space. Unplugging and switching chargers is a tremendous hassle, and chargers are easily lost. A related problem is that most chargers that come with devices typically require wall voltage AC outlet power, even though many people spend much of their time in locations such as cars, airplanes etc. where AC power is not readily available. Another related problem relates to the fact that it is often useful for some of the devices described above to be able to easily exchange data, such as synchronizing phone number data between phones and computers, or exchanging pictures between cameras, phones and computers. To exchange data, these devices often need to be connected by a USB or other specific type of cable. The cables are easily misplaced and the synchronization cables plus power and chargers can take up more space than the device itself. General solutions to any of these problems can be expensive to manufacture and be unreliable when active electronics are used within the core housing component.

### SUMMARY OF THE INVENTION

The invention is a device with three or more electrical/electronic connectors, two of which are for transferring both power and data, and the remaining connectors are for just for transfer of power. Within the housing, there is a power and data cable that couples the two power and data connectors. The power-only connectors are coupled to the power wires of the power and data cable. This coupling may be passive involving no resistors or other electronic components. The power cable is wired directly to the power lines of the power and data cable.

The power and data connectors have female and male connectors at either end. The power-only connector is physically different from the other two data and power connectors making it easy for a user to distinguish the two.

In the preferred embodiment, the connector that attaches to a power or data source is connected by a long cable to the housing. This cable may or may not be wound up around a spring loaded cable retractor that keeps the cable from getting tangled when the extra length is not needed. This is yet another physical attribute of the invention that helps the user distinguish between the different connectors.

### BRIEF DESCRIPTION OF THE DRAWINGS

The operation and components of this invention can be understood by a set of drawings.

FIG. 1 (prior art) illustrates a prior power and data connection apparatus.

FIG. 2 illustrates the preferred embodiment of the apparatus.

FIG. 3 is a schematic illustration of the power and data connections between the input and multiple output connectors.

### REFERENCE NUMERALS IN DRAWINGS

10 AC to DC converter
11 electronic cable
12 interconnection circuit
13 electronic cable
14 interconnection data circuit
100 USB male connectors
101 electronic cable
102 housing
103 electronic cable
104 electronic cable
105 power connectors
106 USB female connectors
200 electronic cable
201 electronic cable
202 electronic cable

### PRIOR ART

The invention disclosed in this document is an innovative and unique solution to the above problems that has distinct advantages over the prior art which will be described below.

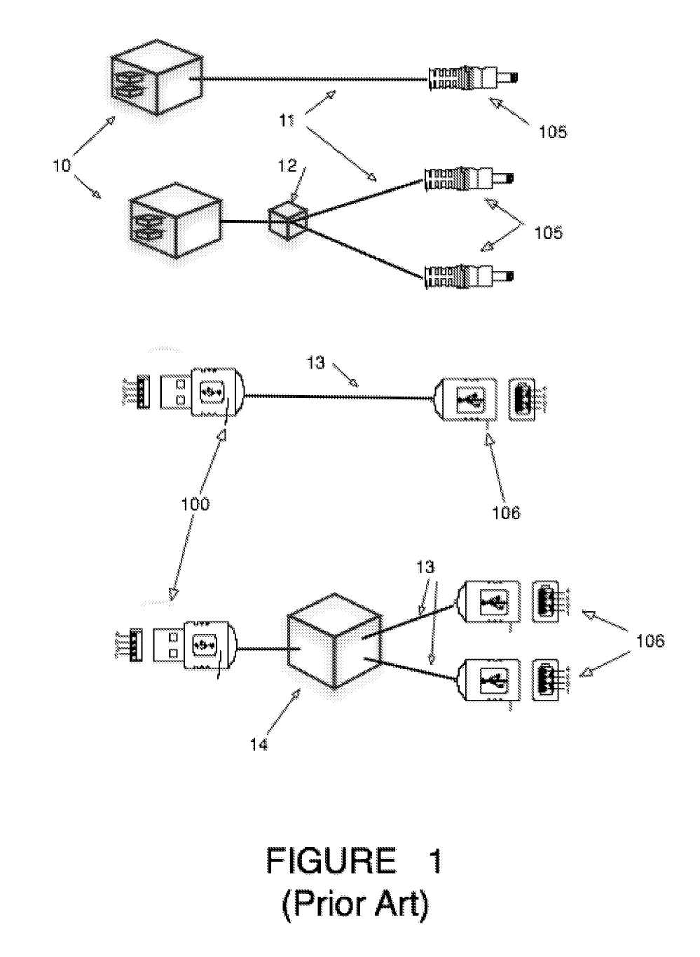

The prior art can be classified in four ways as illustrated in FIG. 1. Each type of prior art device has significant limitations for which the present invention provides a solution.

In one prior art device, an AC to DC converter 10 is directly connected to a power connector 105 by an ordinary cable 11. This is the most common method of supplying power to a portable electronic device or to charge the battery within a portable electronic device. This type of device has the following limitations:
a) it cannot facilitate the exchange of data between devices
b) it can only use an AC (alternating current) outlet as it's source of power
c) it can only charge a single device at one time
d) it cannot interface with devices requiring USB connectors
e) it cannot charge devices with any connector style other than the single type of connector provided.

A second type of prior art device is able to power or charge multiple devices from a single power source 10. The power lines of a cable 11 are coupled by special circuitry 12 to ensure proper voltage to the power connectors 105. This type of device has the following limitations:
a) it cannot facilitate the exchange of data between devices
b) it can only use an AC (alternating current) outlet as it's source of power
c) it cannot interface with devices requiring USB connectors
d) it cannot charge devices with any connector style other than the single type of connector provided.

A third style of prior art device addresses connecting devices with a cable 13 enclosing both power and data wires. The common practice is an extension cable with a USB male connector 100 at one end and a USB female connector 106 at the other end. This type of device has the following limitations:
a) it can only facilitate the exchange of data between 2 devices
b) it can only use a USB enabled device as it's source of power
c) it can only charge a single device at one time
d) it cannot interface with devices requiring connectors other than USB connectors
e) it cannot charge devices with any connector style other than the single type of connector provided.

A fourth style of prior art device is able to couple multiple devices. Multiple USB devices can be coupled to the female USB connectors 106 from a single USB male connector 100 provided there is an active circuitry 14 that ensures proper power voltage and proper sequencing of the digital data transfers when multiple devices simultaneously attempt to communicate. This type of device has the following limitations:
a) it cannot use power sources other than USB enabled devices
b) it cannot charge devices with any connector style other than the single type of connector provided
c) it can only charge and exchange data between devices with USB style connectors
d) it requires complex circuitry to correctly couple the USB data lines.

In each of these situations, either a single device is supported or devices cannot exchange data or a complex and expensive active circuit is required to support multiple devices.

### DETAILED DESCRIPTION OF THE INVENTION

The preferred embodiment is a power supply for electronic devices that has a single input 100 and multiple outputs 105 and 106. The input to the device may be a transformer to convert AC wall power 10 to a DC voltage that is correct to charge or power electronic devices. Most cell phones and many other devices can be charged or powered by 5 to 6 volts DC, though other voltages may be desired for particular devices. The device of this embodiment of the invention may have 2 or more output cables 103 and 104 or connectors so that it can power or charge two or more electronic devices from the group described above simultaneously or at least let them be connected simultaneously. Each device may require a different type of connector, and adapters may be used to create an electrical connection to any type of device.

In a related embodiment, the device of the invention may disconnect from the AC/DC transformer, and alternatively connect to a car cigarette lighter adapter and voltage converter. The resulting device of this embodiment is capable of charging or powering multiple electronic devices from a cigarette lighter. A similar solution would adapt the device to power adapters found on airplanes.

In a related embodiment, the device of the invention may disconnect from the AC/DC transformer, and alternatively connect to a USB port of a computer. Computer USB connections can provide a certain amount of power at approximately 5 volts. There may be an intermediate connector, or the device of the invention may use a USB connector as the default connector between the outputs and the AC adapter when an AC adapter is used. The resulting device of this embodiment is capable of charging or powering multiple electronic devices from any other device that has a USB port such as a computer. Any computer port that supplies power, such as RS232 or Firewire can be used in place of USB.

The preferred version of this embodiment of this device has connectors so that it can use, in a replaceable fashion, an AC/DC adapter, a cigarette lighter adapter, and a USB connector on the input side, and it would have one cell phone type connector for one output 105 and one USB connector 106 for another output. The device may have 2 outputs or it may have more than 2 outputs. Adapter connectors may be used to connect the cell phone style connector to charge or power other devices. Adapter connectors may be used to connect the USB connector output 106 to charge, power or exchange data with other devices requiring other connectors. Therefore the device of this embodiment of the invention can provide power to multiple electronic devices and it can also simultaneously exchange data between devices. Data may be exchanged between the device on the output and a computer or other device connected to the input via a USB or other connector.

This device may use a retractable cable 102 between the input power source and the location where the output cables are connected, or it may use one or more retractable cables as output cables or it may use no retractable cables. Retractable cables such as Zip-LinQ or other types or retractable cables may be used. The retractable cables may have USB or other connectors on one or both ends.

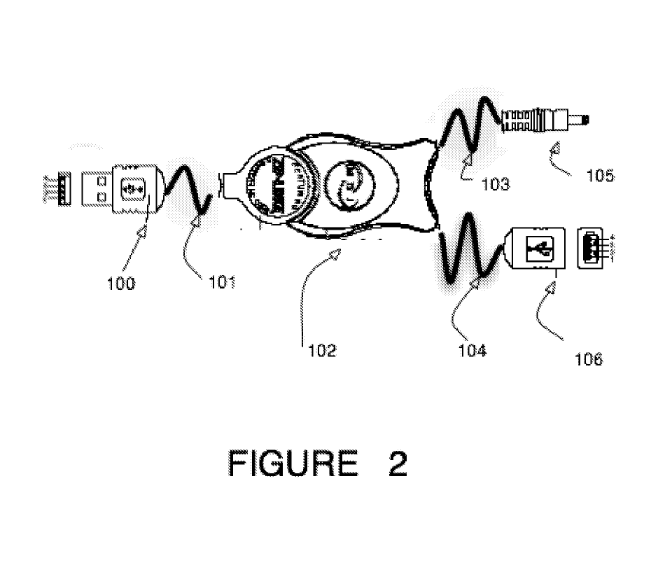

In FIG. 2 three cables 101, 103, and 104 are shown. One connects the USB male input connector 100 to the housing 102. Another cable 104 connects the USB female output connector 106 to the housing 102. A third cable 103 connects the power output connector 105 to the housing 102.

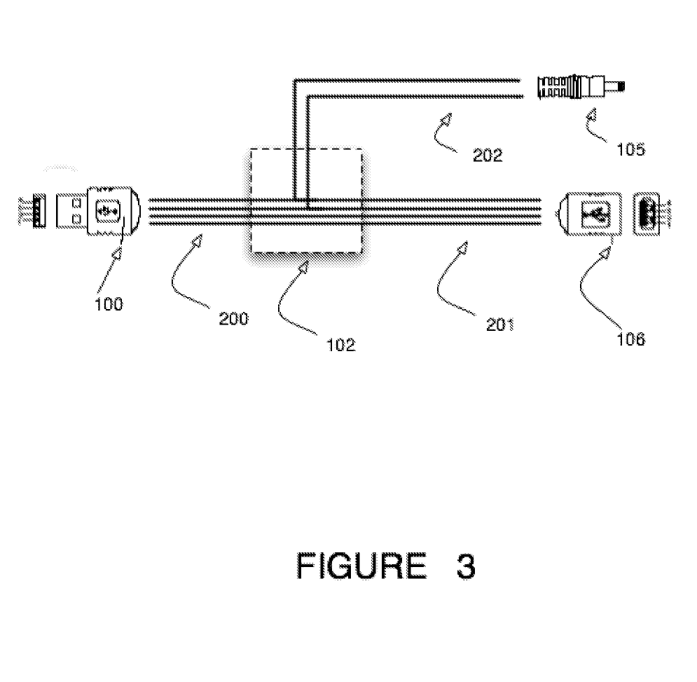

FIG. 3 illustrates how the wires within each of these cables are connected. The USB male input connector 100, the USB female output connector 106, the power output connector 105 are all shown to be coupled within the housing 102. The two power wires within the cables 200 and 201 that couple to the connectors 105 and 106 are connected to create the correct power continuity. Two power wires within the cable 202 that couple to the power connector 105 are connected to the correct power wired within cable 200 so that power from connector 100 is transmitted to connector 105.

What is claimed is:

1. A power and data communication apparatus for providing electric power to one or more devices and exchanging data between two devices, comprising:
a) a first electronic connector capable of transmitting electric power and electronic data
b) a second connector capable of transmitting electric power and electronic data
c) a means of transmitting electric power and data between said first and second connectors
d) a third connector configured to transmit power only
e) a means of transmitting electric power between said first connector and said power only connector(s)
whereby electric power and data can be transmitted from a device that can connect to said first connector to other devices that can connect to said second connector and power can be transmitted to other devices that can connect to said third connector.

2. The apparatus of claim 1 wherein
a) said first connector is a USB (universal serial bus) male connector
b) said second connector is a USB female connector
c) said means of transmitting electric power and data between said first and second connectors comprises an electronic cable with one or more conductive elements and
d) said means of transmitting electric power and data between said first connector and third connector comprises an electronic cable with one or more conductive elements.

3. The apparatus of claim 2 further comprising
a) a second USB female connector coupled to said USB male connector and electrically coupled to
b) an electric power source selected from the group consisting of AC to DC converters, DC power sources, batteries and voltage converters
whereby electric power can be transmitted from said electric power source to said second connector and said third connector(s).

4. The apparatus of claim 1 in which said first connector is a USB male connector and is capable of being connected to a USB connector of a computer.

5. The apparatus of claim 2 further comprising a second USB male connector connected to said USB female connector.

6. The apparatus of claim 2 further comprising a fourth connector which is coupled to said USB female connector for transmission of electric power.

7. The apparatus of claim 1 wherein said third connector is a male barrel type power connector.

8. The apparatus of claim 1 further comprising a housing.

9. The apparatus of claim 1 in which said second connector is configured to transmit power only.

10. The apparatus of claim 2 further comprising a housing.

11. The apparatus of claim 2 further comprising a retractor whereby the unused length of said electronic cables can be neatly rolled up and prevented from tangling.

12. The apparatus of claim 1 further comprising
a connector assembly with a proximal end coupled to said third connector and a distal end with an operative shape that is different than said third connector
whereby said apparatus can transmit power to a variety of devices that require various operative connector shapes for electrical connection.

13. An electronic charging and data communicating apparatus, comprising:
a) a first data and power connector having one or more electrical power leads and one or more electronic data leads
b) a second data and power connector
c) a power connector
d) an electronic data and power cable s coupled to said first connector and coupled to said second connector in a manner that allows both electric power and electronic data to be transmitted between said first and second connectors
e) an electronic power cable coupled to said power connector and coupled to said electric power leads of said first connector
whereby electric power and data can be transmitted from a device that can connect to said first connector to other devices that can connect to said second connector and power can be transmitted to other devices that can connect to said power connector.

14. An electronic charging and data communication apparatus allowing power and/or data to be transmitted from a USB enabled device to a non-USB enabled device comprising:
a) a USB (universal serial bus) male connector having one or more power leads
b) a non-USB connector having one or more power leads
c) an electrical connection means connecting said power leads of said USB connector to said power leads of said non-USB connector so that power can be transmitted from a device connected to said USB connector to a device connected to said non-USB connector.

15. The electronic charging and data communication apparatus of claim 14 further comprising
a) one or more data leads in said USB connector and
b) one or more data leads in said non-USB connector and
c) an electrical connection means connecting said data leads of said USB connector to said data leads of said non-USB connector so that data can be transmitted from a device connected to said USB connector to a device connected to said non-USB connector.
